(19) United States
(12) Patent Application Publication
(10) Pub. No.: US 2020/0085153 A1
(43) Pub. Date: Mar. 19, 2020

(54) Dual Display Wristband

(71) Applicant: Scott Dummert, Waukesha, WI (US)

(72) Inventor: Scott Dummert, Waukesha, WI (US)

(21) Appl. No.: 16/573,077

(22) Filed: Sep. 17, 2019

Related U.S. Application Data
(60) Provisional application No. 62/733,177, filed on Sep. 19, 2018.

(51) Int. Cl. A44C 5/00; G06F 1/16

(52) U.S. Cl. CPC A44C 5/0007; G06F 1/163; H04B 2001/3861; H04M 2250/22; G06F 1/1647

(57) ABSTRACT

A dual display wristband. The dual display wristband includes a band, at least one power source, at least one wireless transceiver, at least one processor, a first display and a second display. The band can be worn around a person's wrist. The first display and the second display are connected to the band. At least one wireless transceiver is operably connected to each display and can transmit a visual or audio signal to either or both displays. At least one processor can receive customization commands from a device. At least one processor can determine the visual or audio signals to transmit via wireless transceiver to either or both displays.

### CROSS REFERENCE TO RELATED APPLICATIONS

This application claims the benefit of U.S. Provisional Application No. 62/733,177 filed on Sep. 19, 2018. The above identified patent application is herein incorporated by reference in its entirety to provide continuity of disclosure.

### BACKGROUND OF THE INVENTION

The present invention relates to wristband displays. More particularly, the present invention provides for a wristband with dual displays, wherein at least one processor is configured to receive commands customizing the information that is displayed on either display.

Many individuals wear a device on their wrist that enables them to receive electronic alerts. These devices typically consist of a solitary display. The screen size on these displays is typically very small, making it difficult to display more than one item at a time. Additionally, the display can be seen by nearby individuals resulting in the user's loss of privacy when incoming texts, emails, or other private correspondence are displayed on the screen. In addition, because all information is displayed on the solitary screen, the user is unable to customize their device to separate alerts when using such a device. Accordingly, a wristband with dual displays, wherein at least one processor is configured to receive commands customizing the information that is displayed on either display is desired.

The present invention substantially diverges in design elements from the known art and consequently it is clear that there is a need in the art for an improvement to existing wristband displays. In this regard the present invention substantially fulfills these needs.

### SUMMARY OF THE INVENTION

In view of the foregoing disadvantages inherent in the known types of wristband displays now present in the known art, the present invention provides a dual display wristband wherein the same can be utilized for providing convenience and privacy for the user. The dual display wristband includes a band, at least one power source, at least one wireless transceiver, at least one processor, a first display and a second display. The band is configured to be worn around a person's wrist. The first display and the second display are connected to the band. At least one wireless transceiver is operably connected to each display and configured to transmit a visual or audio signal to either or both displays. At least one processor is configured to receive customization commands from a device. At least one processor is configured to determine the visual or audio signals to transmit via wireless transceiver to either or both displays.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the dual display wristband.

FIG. 2 shows a topside and underside view of an embodiment of the dual display wristband disposed on a user's wrist.

FIG. 3 shows a perspective view of multiple embodiments of screens used in the dual display wristband.

FIG. 4 shows a schematic diagram of an embodiment of the dual display wristband.

FIG. 5 shows a schematic diagram of an embodiment of the dual display wristband, wherein each display comprises an independent power source and wireless transceiver.

### DETAILED DESCRIPTION OF THE INVENTION

Reference is made herein to the attached drawings. Like reference numerals are used throughout the drawings to depict like or similar elements of the dual display wristband. For the purposes of presenting a brief and clear description of the present invention, a preferred embodiment will be discussed as used for the dual display wristband. The figures are intended for representative purposes only and should not be considered to be limiting in any respect.

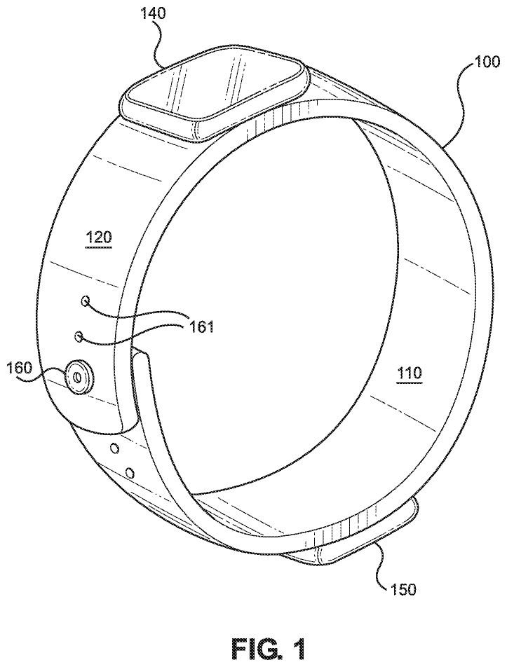

Referring now to FIG. 1, there is shown a perspective view of an embodiment of the dual display wristband. The dual display wristband has a band 100, at least one power source, at least one wireless transceiver, at least one processor, a first display 140 and a second display 150. In the shown embodiment, the band 100 comprises a flexible member with an interior surface 110, configured to rest against a wrist of a user, and an exterior surface 120. In the shown embodiment, the band 100 comprises a snap fastener 160 that is configured to be secured to a complementary snap fastener. One of ordinary skill in the art will understand that this disclosure is not limiting in any way the manner in which the first display 140 and the second display 150 are connected to the band 100, including but not limited to a strap, interconnecting links, or a mount disposed on the surface of the band 100. One of ordinary skill in the art will also realize there are many ways to adjust the diameter of the wristband when disposed on a user's wrist and that the present disclosure in not limiting in such manner.

In one embodiment, the snap fastener 160 is disposed on the exterior surface 120 of the band 100 and the complementary snap fastener is disposed on the interior surface 110 of the band. In another embodiment, the band 100 comprises a plurality of complementary snap fasteners disposed linearly along the band 100 at regular intervals. The regular intervals provide a user with a variety of lengths along the band 100 at which they can secure the snap fastener. In this manner, a user can selectively adjust the length of the band 100 to comfortably fit around their wrist. In another embodiment, the band 100 comprises a plurality of apertures 161. In such an embodiment, the snap fastener 160 is sized and configured to pass through a selected aperture. By utilizing the snap fastener 160, a wearer is able to customize the fit of the band 100 around their wrist in a secured configuration.

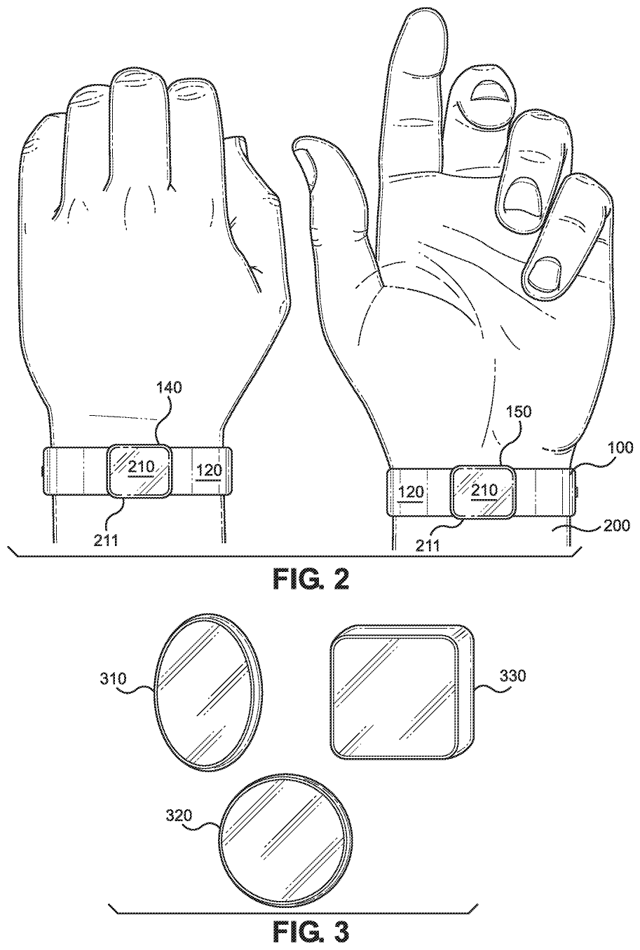

Referring now to FIG. 2, there is shown a topside and underside view of an embodiment of the dual display wristband disposed on a user's wrist. The band 100 is configured to be worn around a wearer's wrist 200. The first display 140 and the second display 150 are disposed on the exterior surface 120 of the band 100. In one embodiment, the first display 140 is disposed opposite the second display 150 when the band 100 is in the secured configuration. In the shown embodiment, the first display 140 and the second display 150 are disposed such that the first display 140 rests on the back of the wearer's wrist 200, and the second display 150 rests on the front of the wearer's wrist 200, when the band 100 is in a secured configuration. In another embodiment, the first display 140 and the second display 150 are disposed at selected positions on the band 100 such that the two displays are not directly opposite each other. Such an off-set configuration is desirable to customize the positioning of the displays to maintain privacy for the wearer. In one embodiment, the second display 150 is slidably affixed to the band 100 such that the wearer can selectively move the second display 150 to a desired location.

In one embodiment, a protective coating 210 is disposed on the exterior surface of each of the first display 140 and the second display 150. The protective coating 210 is configured to prevent damage to each of the displays 140, 150. In one embodiment, the protective coating 210 is a scratch resistant coating. In a further embodiment, a protective edge trim 211 is disposed along the circumference of each of the displays 140, 150. The protective edge trim 211 is configured to prevent damage to the sides and edges of each of the displays 140, 150. In one embodiment, the displays 140, 150 are further configured to accept a touch input. In such embodiments, the wearer is able to interact with the images shown on the displays and manipulate them.

Referring now to FIG. 3, there is shown a perspective view of multiple embodiments of screens used in the dual display wristband. In various embodiments, the first display and the second display comprised a variety of cross-sectional shapes including an elliptical cross-section 310, a circular cross-section 320, and a rectangular cross-section 330, for example. In one embodiment, the first display and the second display comprise different cross-sectional shapes. In another embodiment, the first display and the second display comprise identical cross-sectional shapes. Additionally, in other embodiments, the first display and the second display comprise identical cross-sectional areas. In other embodiments, the first display and the second display comprise different cross-sectional areas. Such a mix of cross-sectional shapes and sizes provides for the ability to customize the aesthetic appearance of the device. Additionally, the variety of shapes and sizes provide for the ability to customize the fit of the device as well as provide additional privacy but utilizing the first display for non-sensitive information, while simultaneously using the second display for sensitive information, for example.

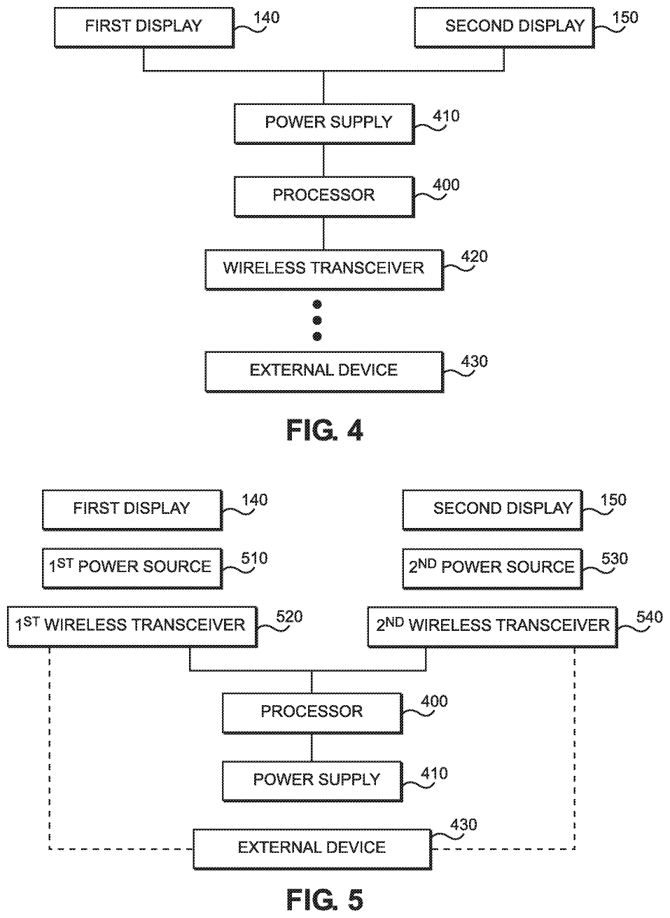

Referring now to FIG. 4 there is shown a schematic diagram of an embodiment of the dual display wristband. The dual display wristband comprises the first display 140 and the second display 150. In the shown embodiment, the first display 140, the second display 150, and a processor 400 are all connected to a power supply 410. The processor 400 is in communication with a wireless transceiver 420. The wireless transceiver 420 is configured to receive input from an external device 430. In various embodiments, the external device 430 is a device capable of wireless transmission, such as a cellphone or a tablet, for example. The external device 430 provides input to the processor 400, via a wireless signal received by the wireless transceiver 420. The input is configured to customize an image presented on each of the first display 140 and the second display 150. In various embodiments, the image presented on the first display 140 is different than the image presented on the second display 150. In such a manner, a wearer is able to utilize the two displays 140, 150 of the present invention to selectively determine which display the images are presented on.

Referring now to FIG. 5 there is shown a schematic diagram of an embodiment of the dual display wristband, wherein each display comprises an independent power source and wireless transceiver. In the shown embodiment, the first display 140 is connected to a first power source 510 and a first wireless transceiver 520. Similarly, the second display 150 is connected to a second power source 530 and a second wireless transceiver 540. The first wireless transceiver 520 and the second wireless transceiver 540 are configured to receive input from an external device 430. The first wireless transceiver 520 and the second wireless transceiver 540 are connected to a processor 400, which is in turn connected to a power supply 410. Similar to the embodiment discussed above, the external device 430 is utilized to provide images to the two displays 140, 150. In the present embodiment, the device utilizes separate and distinct wireless transceivers 520, 540 and power sources 510, 530, which provides the benefit of redundancy of the system, as well as independent control for each display.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A dual display wristband, comprising:
a band having a first display and a second display;
the first display and the second display affixed to an exterior surface of the band;
a processor in communication with the first display and the second display;
the processor in communication with a wireless transceiver;
the processor configured to receive an input from an external device;
wherein the input is configured to customize an image presented on each of the first display and the second display; and
a power source operably connected to the wireless transceiver, the processor, the first display, and the second display.

2) The dual display wristband of claim 1, wherein the first display is disposed opposite the second display when the band is in a secured position.

3) The dual display wristband of claim 1, wherein the band further comprises a snap fastener disposed on an exterior surface of the band and the complementary snap fastener is disposed on an interior surface of the band.

4) The dual display wristband of claim 3, further comprising a plurality of complementary snap fasteners disposed linearly along the band at regular intervals.

5) The dual display wristband of claim 1, wherein a protective coating is disposed on the exterior surface of each of the first and second displays.

6) The dual display wristband of claim 1, wherein a protective edge trim is disposed on a circumference of each of the first and the second display.

7) The dual display wristband of claim 1, wherein each of the first and second displays is configured to accept a touch input.

8) The dual display wristband of claim 1, wherein the first display and the second display comprise an identical cross-sectional area.

9) The dual display wristband of claim 1, wherein the first display and the second display comprise a different cross-sectional area.

10) The dual display wristband of claim 1, wherein the first display and the second display comprise an identical cross-sectional shape.

11) The dual display wristband of claim 1, wherein the first display and the second display comprise a different cross-sectional shape.

12) A dual display wristband, comprising:
a band having a first display and a second display;
the first display and the second display affixed to an exterior surface of the band;
a processor in communication with the first display and the second display;
the first display further comprising a first power source and a first wireless transceiver;
the second display further comprising a second power source and a second wireless transceiver;
the processor in communication with the first wireless transceiver and the second wireless transceiver;
the first wireless transceiver and the second wireless transceiver configured to receive an input from an external device;
wherein the input is configured to customize an image presented on each of the first display and the second display; and
a power source operably connected to the processor, the first display, and the second display.

13) The dual display wristband of claim 12, wherein the first display is disposed opposite the second display when the band is in a secured position.

14) The dual display wristband of claim 12, wherein the band further comprises a snap fastener disposed on an exterior surface of the band and the complementary snap fastener is disposed on an interior surface of the band.

15) The dual display wristband of claim 14, further comprising a plurality of complementary snap fasteners disposed linearly along the band at regular intervals.

16) The dual display wristband of claim 12, wherein a protective coating is disposed on the exterior surface of each of the first and second displays.

17) The dual display wristband of claim 12, wherein a protective edge trim is disposed on a circumference of each of the first and the second display.

18) The dual display wristband of claim 12, wherein each of the first and second displays is configured to accept a touch input.

19) The dual display wristband of claim 12, wherein the first display and the second display comprise a different cross-sectional area.

20) The dual display wristband of claim 12, wherein the first display and the second display comprise a different cross-sectional shape.
